(19) United States
(12) Patent Application Publication
(10) Pub. No.: US 2024/0253569 A1
(43) Pub. Date: Aug. 1, 2024

(54) DIGITAL WINDOW

(71) Applicant: Winnebago Industries, Inc., Eden Prairie, MN (US)

(72) Inventor: John Bonczyk, Minnetonka, MN (US)

(21) Appl. No.: 18/424,265

(22) Filed: Jan. 26, 2024

Related U.S. Application Data
(60) Provisional application No. 63/441,937, filed on Jan. 30, 2023.

(51) Int. Cl. B60R 1/29; B60N 2/30; B60P 3/36; B60R 11/02

(52) U.S. Cl. CPC B60R 1/29; B60N 2/3054; B60P 3/36; B60R 11/0229; B60R 2300/50; B60R 2300/8006

(57) ABSTRACT

A recreational vehicle includes a body that houses an interior living space that is separated from an exterior space by a wall. The wall includes an interior-facing surface and an exterior-facing surface. The recreational vehicle also includes a digital window system, which has a display assembly and a camera. The display assembly includes a display and mounted to the interior-facing surface. The camera includes an optical image sensor, is communicatively coupled to the display, and is mounted to the exterior-facing surface.

### CROSS REFERENCE TO RELATED APPLICATION

This application claims priority to U.S. Provisional Application No. 63/441,937, filed Jan. 30, 2023, which is herein incorporated by reference in its entirety.

### SUMMARY

In certain embodiments, a recreational vehicle includes a body that houses an interior living space that is separated from an exterior space by a wall. The wall includes an interior-facing surface and an exterior-facing surface. The recreational vehicle also includes a digital window system, which has a display assembly and a camera. The display assembly includes a display and mounted to the interior-facing surface. The camera includes an optical image sensor, is communicatively coupled to the display, and is mounted to the exterior-facing surface.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a recreational vehicle, in accordance with certain embodiments of the present disclosure.

FIG. 2 shows a schematic floor plan of the recreational vehicle of FIG. 1, in accordance with certain embodiments of the present disclosure.

FIG. 3 shows a schematic cut-away view of the digital window assembly, in accordance with certain embodiments of the present disclosure.

FIG. 4 shows a schematic front view of a display portion of a digital window assembly positioned within an interior of the recreational vehicle, in accordance with certain embodiments of the present disclosure.

FIG. 5 shows a schematic side view of an interior of the recreational vehicle, in accordance with certain embodiments of the present disclosure.

FIG. 6 shows a schematic side view of an interior of a recreational vehicle with a cabinet and pop-up television assembly.

FIGS. 7A and 7B show schematic side views of a camera portion of the digital window assembly, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope the appended claims.

### DETAILED DESCRIPTION

Certain embodiments of the present disclosure are directed to digital window systems, which help address one or more issues in designing and/or using recreational vehicles.

The first issue addressed is the usage of space for entertainment systems that include a television. Televisions are sometimes housed in a dedicated cabinet that rests on the floor and that includes a mechanism for allowing the television to retract into the cabinet when not in use and lifted out of the cabinet for use. But dedicated cabinets consume floorspace. Certain embodiments of the present disclosure eliminate the need for dedicated cabinets that rest on the floor to house a television.

The second issue addressed is the tension between the desire for privacy and the desire for viewing the surroundings outside the recreational vehicle. Certain embodiments of the present disclosure allow occupants of the recreational vehicle to replicate windows using their television.

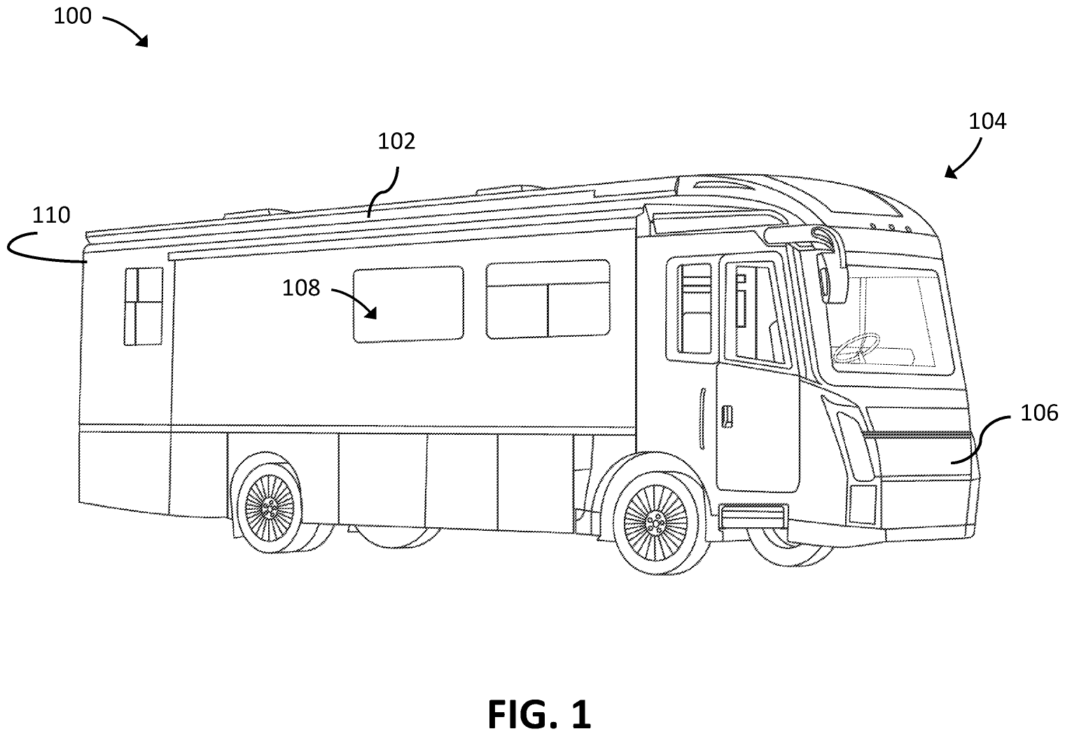

FIG. 1 shows a recreational vehicle 100 having a body 102 that houses a cab area 104 at a front end 106 of the recreational vehicle 100 and a living space area 108 positioned between the cab area 104 and a rear end 110 of the recreational vehicle 100. Although FIG. 1 shows what is typically referred to as a Class A recreational vehicle, embodiments of the present disclosure can be used in other types of motorized recreational vehicles (e.g., Class B recreational vehicles, Class C recreational vehicles, and the like), non-motorized types of recreational vehicles (e.g., 5th wheel trailers, travel trailers, and the like), and marine recreational vehicles (e.g., boats).

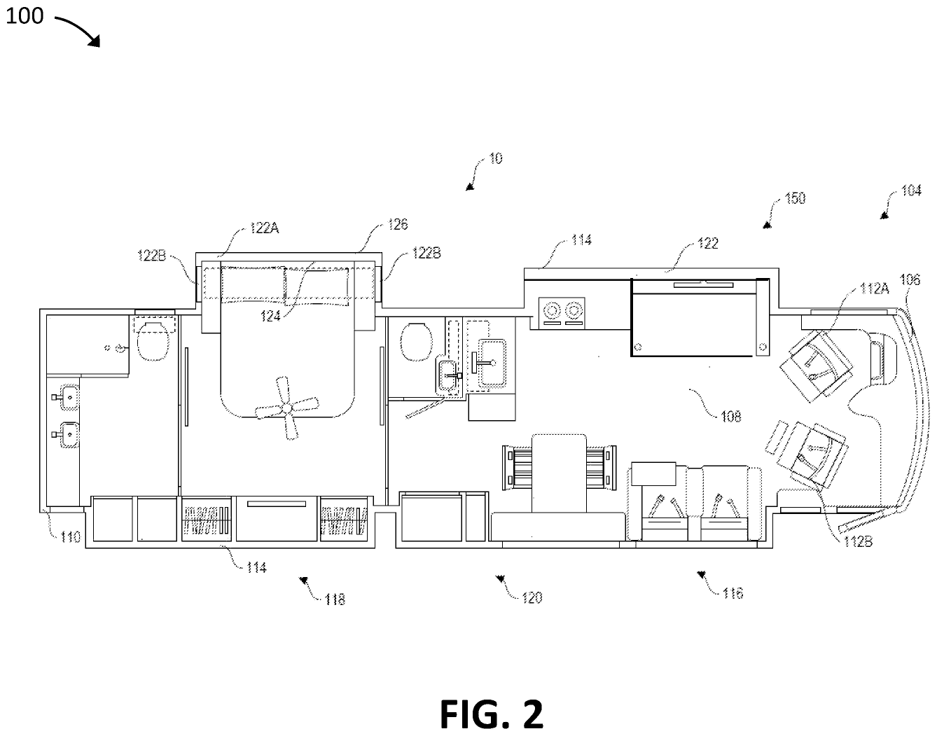

FIG. 2 shows a top-down view of a floorplan of the recreational vehicle 100. The floorplan is just one example of how embodiments of the present disclosure can be used with recreational vehicles such as the recreational vehicle 100.

As shown in FIG. 2, the recreational vehicle 100 can include a driver's seat 112A and a passenger seat 112B located in the cab area 104. The driver's seat 112A and the passenger seat 112B can rotate to face various directions (e.g., forward when driving, aft when parked, and therebetween).

The recreational vehicle 100 includes multiple slideouts 114A-D which can extend and retract. When the recreational vehicle 100 is parked, the slideouts 114A-D can be extended to increase the amount of space in the living space area 108. The first and second slideouts 114A and 114B are located behind the cab area 104 and on opposing sides of the recreational vehicle 100 in a front living area 116, and the third and fourth slideouts 114C and 114D are located in a rear bedroom area 118 on opposing sides of the recreational vehicle 100. A kitchen area 120 can be positioned between the front living area 116 and the rear bedroom area 118.

The slideouts 114A-D can support various pieces of furniture. As will be described in more detail below, certain features of the present disclosure increase the amount of space available for furniture for seating (e.g., chairs and couches) and decrease the amount of space consumed by dedicated cabinets for televisions.

The body 104 includes various walls 122 that separate the interior living space area 108 from an exterior 10 (e.g., outdoor area outside of the recreational vehicle 100). Each slideout 114A-D has walls 122 that move with the respective slideouts 114A-D, while the non-slideout walls have a fixed position. Each slideout 114A-D can include three walls: one wall 122A that extends parallel to a longitudinal axis of the recreational vehicle 100 and two sidewalls 122B that both extend perpendicular to the other wall 122A. In the retracted position (e.g., when travelling), the wall 122A that extends parallel to the longitudinal axis is coplanar with the fixed walls on the given side of the body 104. Each wall 122 includes an interior facing surface 124 and an exterior facing surface 126 on opposite sides of the wall 122.

The recreational vehicle 100 includes a digital window system 150, which is described in more detail below. The digital window system 150 can replicate a window using a display such as a television while also eliminating the need for using dedicated cabinets that rest on the floor to house the display. The digital window system 150 can be positioned on a fixed wall or a wall of one of the slideouts 114A-D, as shown in FIG. 2.

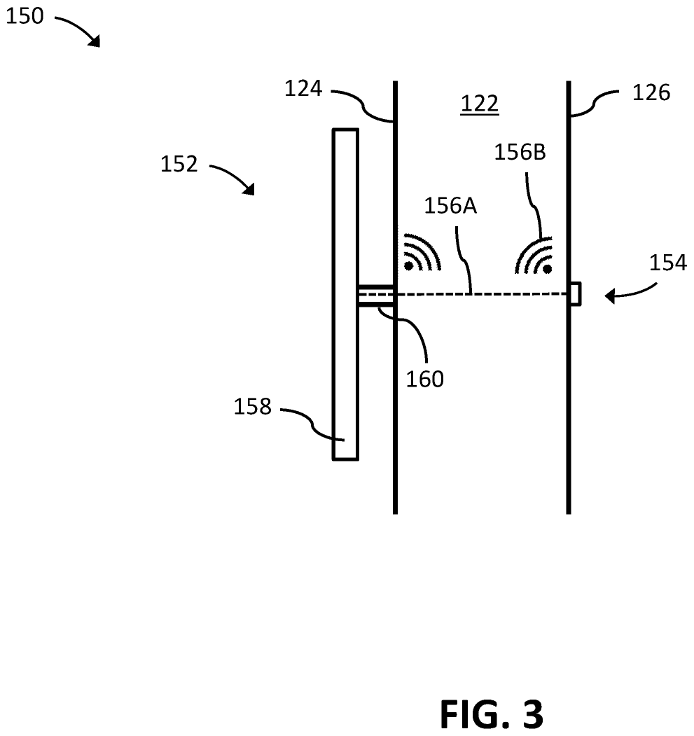

FIG. 3 shows a schematic of the digital window system 150. The digital window system 150 includes a display assembly 152 that is positioned within the interior living space area 108 and a camera 154 (e.g., a video camera) that is positioned outside the recreational vehicle 100 (e.g., facing the exterior 10). Put another way, the display assembly 152 is positioned on one side of the wall 122 and the camera 154 is positioned on an opposite side of the wall 122 as the display assembly 152. The display assembly 152 and the camera 154 are communicatively coupled to each other. For example, the display assembly 152 and the camera 154 can communicate over one or more wires 156A (shown in a dashed line in FIG. 3) such as audio/video cables or via wireless communication 156B such as Bluetooth or another wireless protocol. If wired together, the wire(s) 156A can extend through an opening in the wall 122 and between the camera 152 and the display assembly 152. Further, one wire 156A can provide power to the camera 154 and another wire can provide a path for electrical signals (e.g., a path for video signals) to pass from the camera 154 to the display assembly 152.

The display assembly 152 is coupled to the interior facing surface 124 and includes a display 158 such as a television or a monitor. The display assembly 152 can also include a mounting assembly 160 that is coupled between the display 158 and the wall 122 such that the display assembly 152 is coupled to the wall 122. For example, the mounting assembly 160 can include one or more brackets that are directly coupled to the display 158 on one end and to the wall 122 on the other end. The mounting assembly 160 can allow a user to alter the position of the display 158. The camera 154 can be coupled to the exterior facing surface 126 of the wall 122 and arranged such that the camera 154 is facing the exterior 10 to record a view external to the recreational vehicle 100.

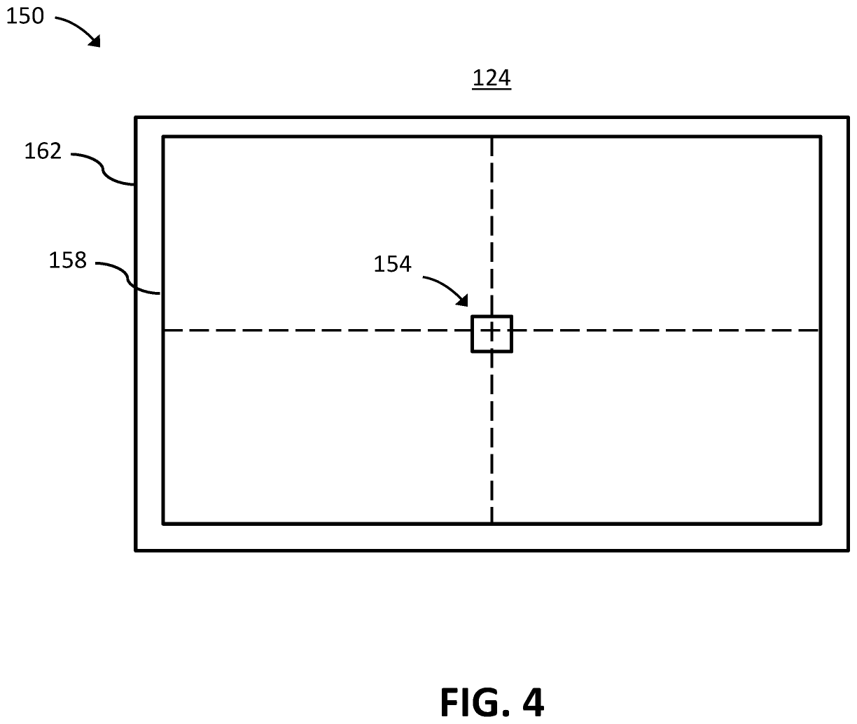

FIG. 4 shows the display 158 as viewed from inside the body of the recreational vehicle while looking towards the interior facing surface 124 of the wall 122 on which the display assembly 152 is coupled to. The position of the camera 154 is also shown in FIG. 4 relative to the display 158, although the camera 154 would be positioned exterior to the body of the recreational vehicle as described above with respect to FIG. 3.

The display 158 has an outer boundary 162. For example, the outer boundary 162 has an upper boundary portion, a lower boundary portion, and two side boundary portions that together form the outer boundary 162 of the display 158. If this outer boundary 162 were to be projected directly forward in space (e.g., perpendicular to a front surface of the display 158 or perpendicular to the interior facing surface 124), the outer boundary 162 would define an envelope. As shown in FIG. 4, the camera 154 is positioned such that the camera 154 is within the envelope defined by the outer boundary 162 of the display 158. For example, the camera 154 is positioned at a height and lateral position relative to the height and position of the display 158 such that camera 154 is within the envelope defined by the outer boundary 162 projected forward in space. In certain embodiments, the camera 154 is positioned within an envelope defined by a circle having a radius (e.g., a 12 inch radius, a 6 inch radius, a 3 inch radius) from a center point of the display 158 (e.g., where the two dashed lines intersect in FIG. 4). Although the camera 154 could be positioned outside an envelope defined by the display 158, positioning the camera 154 as described immediately above assists with replicating a window-like view on the display 158.

When powered on, the camera 154 generates images in the form of streaming video of the exterior of the recreational vehicle 100. The generated images are sent to the display 158, which displays the images on a screen. When displayed, the generated images can replicate a window. For example, the generated images can be displayed on the display 158 in such a way that the display 158 looks as if one were viewing the exterior of the recreational vehicle through a window in the wall of the recreational vehicle. As such, the display 158 can display a digital window.

In certain embodiments, the digital window displays live video of what is positioned exterior to the recreational vehicle. For example, if a person or animal goes into the field of view of the camera 154, the display 158 would show live images of the person or animal to the extent they remain in the field of view of the camera 154. The camera 154 can be positioned and arranged such that the field of view of the camera 154 closely replicates what the view would look like if the display 158 was a window (e.g., glass window) positioned in an opening in a wall of the recreational vehicle. For example, the field of view of the camera 154 can have an outer boundary that is approximately the same dimension as the outer boundary 162 of the display 158.

In certain embodiments, the images generated by the camera 154 are undistorted. For example, to the extent the camera 154 has a lens, the lens can be designed to limit distortion of objects in the field of view of the camera 154 (e.g., not a wide angle lens). As another example, the generated images can be displayed to show objects as their actual size and distance from the camera 154. Further, the images shown on the display 158 can be the raw (e.g., unfiltered) images generated by the camera 154. In other embodiments, the camera 154 can be programmed to include various user-selectable filters to customize how the images are shown on the display 158.

In certain embodiments, the view of the camera 154 can be modified by users. For example, a user may control the camera 154 to generate modified, magnified images of the exterior 10 (e.g., by using a zoom feature). Further, the camera 154 may include or be coupled to an actuator device (e.g., a motor) that can be controlled by users to rotate the camera 154 to change the view captured by the camera 154 and shown on the display 158. Additionally or alternatively, the camera 154 may be mounted such that a user can manually alter the view captured by the camera 154 by physically rotating the position of the camera 154.

The display 158 can be powered off when occupants do not desire to view a digital window. Further, the display 158 can also function as a normal television and display movies, video games, etc. In certain embodiments, the digital window view can be selected for display by selecting a particular channel or input on the display 158. For example, if the camera 154 communicates the images it generates via an audio/video interface such as high-definition multimedia interface (HDMI) or another interface, the digital window view could be selected by selecting an HDMI input channel on the display 158. In certain embodiments, to conserve power, the camera 154 can be powered off when the display 158 is powered off.

In certain embodiments, the camera 154 can be used in connection with a security system. For example, the camera 154 can include or be communicatively coupled to a motion sensor (e.g., proximity sensor). When the motion sensor detects motion (e.g., a person or animal passing by the recreational vehicle), the sensor can send a signal that automatically activates (e.g., powers on) the camera 154. The camera 154 can begin to generate images and send the images to the display 158, a recording device (e.g., a data storage device with memory such as a hard disk drive, tape drive, solid state drive, and the like), a remote data storage device (e.g., a cloud-based data storage system) via a wireless connection, and/or one or more smart phone devices (e.g., via a smart phone app).

As previously noted, the digital window system 150 can provide occupants of the recreational vehicle 100 with a live view of the exterior without compromising privacy. Because the digital window system 150 replicates a window view without having an actual window in a wall of the recreational vehicle 100, the occupants can view the exterior but those outside the recreational vehicle 100 cannot view inside the recreational vehicle 100 where the digital window system 150 is positioned. As such, the wall of the recreational vehicle 100 that the digital window system 150 is mounted on can be a windowless wall. In addition to increasing privacy, the digital window system 150 can increase the amount of useable space within the recreational vehicle 100, as described immediately below.

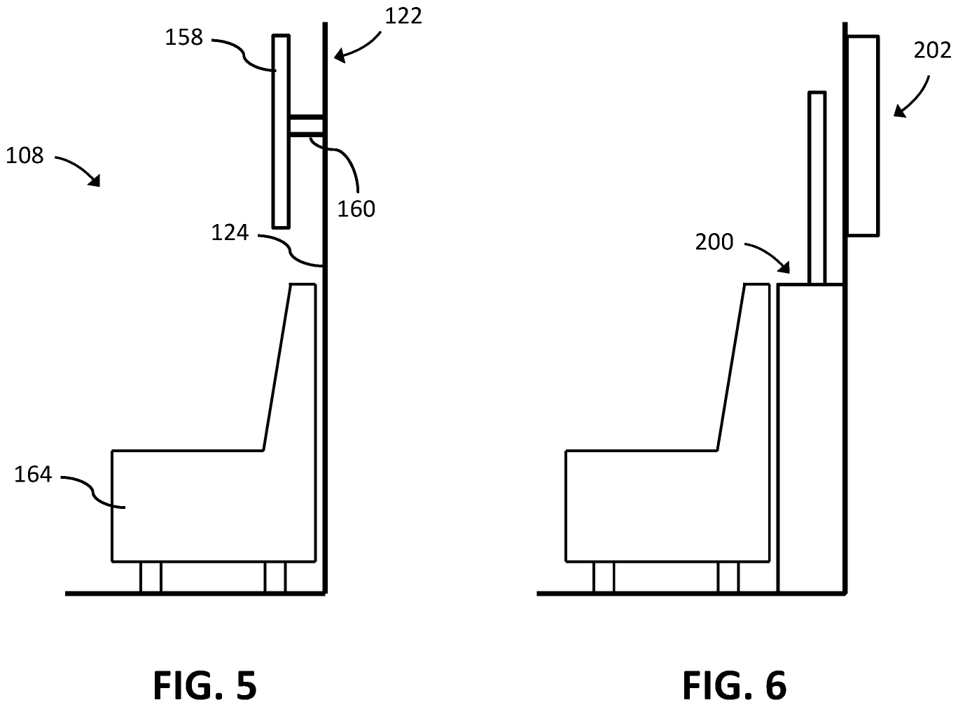

FIG. 5 shows a schematic side view of part of the interior living space area 108 of the recreational vehicle 100. A seat 164 is positioned immediately below the display 158. The seat 164 can be a chair, sofa, sofa bed, and the like. Because the display 158 is positioned above the seat 164, the seat 164 can be positioned close to—or in contact with—the interior-facing surface 124 of the wall 122. The approach shown in FIG. 5 provides more useable interior space compared to designs where a cabinet is used to house a television, such as the design shown in FIG. 6.

In the design of FIG. 6, a cabinet 200 is positioned between a seat and a wall. The cabinet is wide enough (e.g., 6-12 inches) to house a television that can retract into and extend out of the cabinet such that a window 202 can be used when the television is retracted into the cabinet. The space consumed by the cabinet 600 reduces useable space in the interior of the recreational vehicle. In contrast, the design of FIG. 5 can eliminate the use of a cabinet positioned between the seat 164 and the wall 122 and free up more space for furniture or other walkable floor space in the interior of the recreational vehicle.

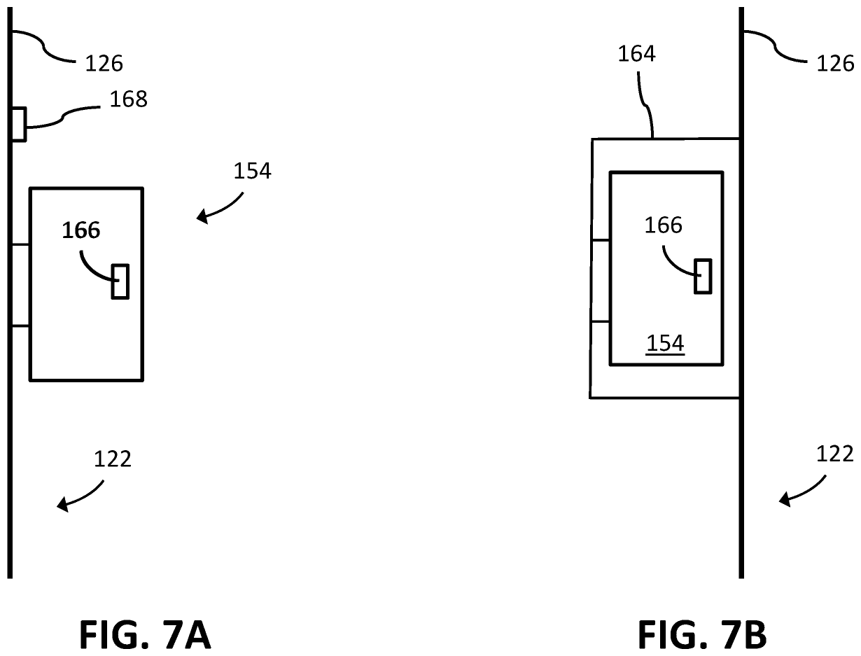

FIGS. 7A and 7B show schematic side views of the camera 154 in different mounting arrangements to the wall 122.

FIG. 7A shows the camera 154 coupled (e.g., directly or indirectly coupled) to the exterior-facing surface 126 of the wall 122. In this arrangement, modifications to the wall 122 of the recreational vehicle 100 can be minimized. For example, if the camera 154 is wired, the wall 122 only needs a small opening to allow one or more wires to pass through the wall 122.

FIG. 7B shows the camera 154 coupled to the wall 122 but positioned in a recess 164 in the wall 122 such that the camera 154 does not extend passed the exterior-facing surface 126 of the wall 122. Although this arrangement requires the recess 164 to be created, the camera 154 is better protected from wind, rain, and other outdoor elements comparted to the arrangement shown in FIG. 7A. Further, positioning the camera 154 in the recess 164 may reduce negative aerodynamic effects and/or may reduce noise generated when driving or pulling the recreational vehicle during transit.

In either arrangement, as noted above, the position of the camera 154 (or an image sensor positioned in the camera 154) could be modified to control the view captured by the camera 154. The camera 154 can include one or more solid-state optical image sensors 166 such as charge-coupled device (CCD) and complementary metal oxide semiconductor (CMOS) image sensors. As noted above, a motion sensor or a proximity sensor 168 can be used in connection with the digital window system to help provide security system functionality.

Although the digital window system 150 shown in the Figures and described above was described in the context of a motorhome recreational vehicle, the digital window system 150 can be used in marine applications. For example, the camera 154 can be positioned on an exterior-facing surface of a wall of a marine recreational vehicle such as a boat while the display assembly 152 is positioned on an interior-facing surface on an opposite side of the wall.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

I claim:

1. A recreational vehicle comprising:
a body housing an interior living space that is separated from an exterior space by a wall, the wall including an interior-facing surface and an exterior-facing surface; and
a digital window system including:
a display assembly including a display and mounted to the interior-facing surface, and
a camera comprising an optical image sensor and communicatively coupled to the display and mounted to the exterior-facing surface.

2. The recreational vehicle of claim 1, wherein the camera is mounted within an envelope defined by the display.

3. The recreational vehicle of claim 1, wherein the camera is mounted within a 6 inch radius of a center of the display.

4. The recreational vehicle of claim 1, wherein the camera is mounted within a 3 inch radius of a center of the display.

5. The recreational vehicle of claim 1, wherein the digital window system is arranged and configured such that the display displays a digital window.

6. The recreational vehicle of claim 5, wherein the digital window is configured to display a live view of the exterior space.

7. The recreational vehicle of claim 6, wherein the live view has a boundary that is approximately the same dimension as an outer boundary of the display.

8. The recreational vehicle of claim 6, wherein the live view is an undistorted view of images generated by the camera.

9. The recreational vehicle of claim 1, wherein the camera and the display are communicatively coupled via a wired connection.

10. The recreational vehicle of claim 1, wherein a portion of the wall to which the display assembly is coupled to does not include any window.

11. The recreational vehicle of claim 1, further comprising:
a first seat positioned immediately below the display assembly.

12. The recreational vehicle of claim 11, further comprising:
a second seat positioned immediately across from the first seat on an opposite side of the interior living space.

13. The recreational vehicle of claim 12, wherein the first seat includes either a chair or a sofa.

14. The recreational vehicle of claim 1, wherein the recreational vehicle does not include a cabinet immediately below the display assembly.

15. The recreational vehicle of claim 1, wherein the display is a television.

16. The recreational vehicle of claim 1, wherein the wall is part of a slide out.

17. The recreational vehicle of claim 16, wherein the wall of the slide out does not include any windows.
